(19) United States
(12) Patent Application Publication
(10) Pub. No.: US 2024/0399999 A1
(43) Pub. Date: Dec. 5, 2024

(54) CONTROL DEVICE

(71) Applicant: Mitsubishi Electric Corporation, Tokyo (JP)

(72) Inventors: Toshiki IKEGASHIRA, Tokyo (JP); Hiroshi OKUYAMA, Tokyo (JP); Yusuke SETO, Tokyo (JP)

(73) Assignee: Mitsubishi Electric Corporation, Tokyo (JP)

(21) Appl. No.: 18/696,409

(22) PCT Filed: Oct. 8, 2021
(86) PCT No.: PCT/JP2021/037278

§ 371 Date: Mar. 28, 2024

(51) Int. Cl. B60R 25/30; H04L 9/40

(52) U.S. Cl. CPC B60R 25/30; H04L 63/1425

(57) ABSTRACT

A control device to detect abnormality of a control target, even when there is a cyber-security attack, and to control it safely. The control device includes a monitoring determination unit for determining whether the list is changed or not changed when communications data is received earlier before a predetermined time when a state of the control target is changed over, in accordance with a relationship between state transition information of a control target acquired by a state acquisition unit and a list of communications data at a normal time stored in a storage unit; a communications monitoring unit—for monitoring communications data corresponding to the list of a control target determined by the monitoring determination unit; and an abnormality determination unit for comparing a monitoring result of the communications monitoring unit with the list, and determining whether unauthorized data is caused or not.

### TECHNICAL FIELD

The disclosure of the present application relates to a control device.

### BACKGROUND ART

In recent years, it can be found that on-vehicle or onboard systems of an automotive or motor vehicle are connected to a vehicle's exterior device(s) by way of a network(s), so that there arise a risk in which a third party having malicious intent makes unauthorized entry into the onboard system(s) from its outside by way of the network(s). If unauthorized entry is made into the onboard system(s), there exists a possibility that, for example, in an ECU (Electronic Control Unit) being a control apparatus or device mounted on an automotive or motor vehicle, a program(s) of the ECU is tampered, and the control thereof is taken over, so that an accident of the motor vehicle might be lead to because it is remotely operated.

In a conventional onboard system, an abnormality handling method is conceivable in which, even when part of a device malfunctions, abnormality caused by the malfunction is detected, so that safe running can be achieved by degenerating a function(s) of the device by means of fail-safe, or by doing the like.

However, when a program(s) is tampered and a mechanism to detect abnormality is changed due to a malfunction, or when information being a subject matter of abnormality detection is disguised as if the information is of a normal value(s), it becomes difficult to detect abnormality as it is.

As a mechanism to detect abnormality of a motor vehicle which receives cyber-security attack, considerations have been underway for a mechanism to detect abnormality by monitoring illegal or unauthorized communications data. Communications data at a normal time is compared with communications data received, whereby considerations have been underway for the mechanism to detect abnormality by performing determination whether or not the communications data belongs to unauthorized communications data.

However, when communications data at a normal time is compared with communications data received, and when abnormality is detected by performing determination whether or not the communications data belongs to unauthorized communications data, there arises a problem in that a work-load for data processing becomes larger in volume if the amount of communications data reaches to an enormous extent. For dealing therewith, a mechanism is required in which, even when cyber-security attack is received, abnormality is detected, while keeping a process work-load being curbed, without causing erroneous detection and/or an escape of detection, so that a motor vehicle is made possible to run safely.

Patent Document 1 states that a monitoring method of communications data is changed in accordance with a state of a motor vehicle, and that abnormal data can be detected without increasing a work-load of data processing.

### RELATED ART DOCUMENT

### Patent Document

[Patent Document 1] Japanese Patent Publication No. 6531011

### SUMMARY OF THE INVENTION

### Problems to be Solved by the Invention

However, in a conventional technology described in Patent Document 1, there arises such a problem as follows. In Patent Document 1, when a state is not accurately acquired when communications data is received immediately before the state is transferred or changed over, it leads to result in monitoring a state of communications data which is different from a state of communications data that is ought to be intrinsically monitored, whereby there exists a possibility that erroneous detection of abnormality detection and/or an escape thereof occur.

The present disclosure in the application concerned has been directed at solving those problems as described above, an object of the disclosure is to obtain a control device in which, in accordance with the relationship among a state of a control target, state transition information on a control target's state and a list of communications data, the communications data monitored is compared with the list, and determination is performed on the comparison whether illegal or unauthorized data is caused or not, whereby, even when cyber-security attack is received, it becomes possible to detect abnormality of the communications data, and to detect abnormality of the control target.

### Means for Solving the Problems

A control device which performs communications of data with a control target in between, the control device, including:
a communications unit for transmitting and receiving communications data with the control target by the control device;
a state acquisition unit for acquiring a state of the control target;
a storage unit for storing communications data of the communications unit at a normal time by forming the communications data as a list of the communications data;
a monitoring determination unit for determining whether the list is changed or not changed when the communications data is received earlier before a predetermined time when a state of the control target is changed over, in accordance with a relationship between state transition information on a state of the control target acquired by the state acquisition unit and the list in the storage unit;
a communications monitoring for monitoring communications data corresponding to the list of the control target determined by the monitoring determination unit; and
an abnormality determination unit for comparing a monitoring result of the communications monitoring unit with the list therein, and determining whether unauthorized data is caused or not on a basis of a comparison result.

### Effects of the Invention

According to the control device disclosed in the disclosure of the application concerned, illegal or unauthorized data is detected without causing erroneous detection and/or an escape of detection even when communications data is received earlier before a predetermined time when the state is changed over, whereby it becomes possible to detect abnormality of a control target, and to safely control the control target.

### BRIEF DESCRIPTION OF DRAWINGS

FIG. 1 is a functional block diagram of a control device according to Embodiment 1;

FIG. 2 is a diagram showing combinations of transition states in which a state transition management unit of the control device extracts, according to Embodiment 1;

FIG. 3 is a diagram for explaining a method of determining a list that combines lists corresponding to two kinds of states, in a monitoring determination unit of the control device, according to Embodiment 1;

FIG. 4 is a diagram for explaining a method of determining a list that combines lists corresponding to three kinds of states, in the monitoring determination unit of the control device, according to Embodiment 1;

FIG. 5 is a diagram for explaining a method of combining lists of two kinds of states in the list production unit of the control device according to Embodiment 1;

FIG. 6 is a flowchart showing abnormality detection processing of the control device according to Embodiment 1;

FIG. 7 is a flowchart showing the processing for determining a monitoring method of the control device according to Embodiment 1; and

FIG. 8 is a diagram showing one example of a hardware configuration of the control device according to Embodiment 1.

### EMBODIMENTS FOR CARRYING OUT THE INVENTION

Hereinafter, the explanation will be made referring to the drawings for the preferred exemplary embodiments of a control device(s) disclosed in the disclosure of the application concerned. Note that, hereinafter, the explanation will be made in detail for a case as a specific example of the control device which is applied to an on-vehicle or onboard control device (ECU) whose control object(s) or target(s) is defined as an automotive or motor vehicle, and as onboard devices or apparatus. The embodiments are each applicable to as an unauthorized entry or intrusion detection system in the control device in a motor vehicle being a control target.

### Embodiment 1

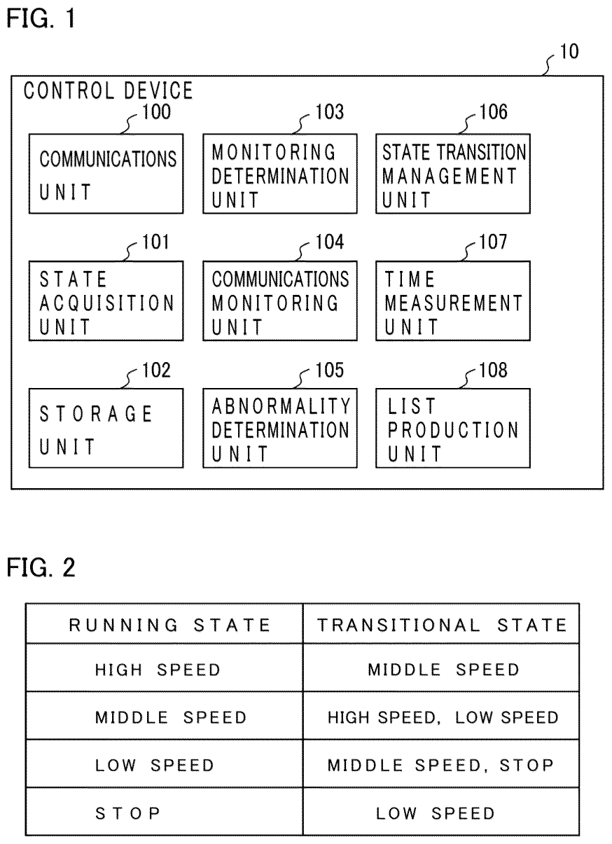

FIG. 1 is a functional block diagram of an onboard control apparatus or device (ECU) to which a control device according to Embodiment 1 is applied. The onboard control device (hereinafter, referred to as a control device 10) in Embodiment 1 is constituted of a communications unit 100, a state acquisition unit 101, a storage unit 102, a monitoring determination unit 103, a communications monitoring unit 104, an abnormality determination unit 105, a state transition management unit 106, a time measurement unit 107 and a list production unit 108, which are provided with the control device.

The control device 10 is an onboard control apparatus or device for performing the control of an automotive or motor vehicle. The control device 10 is connected to other control devices in the interior of a motor vehicle by way of a communications line(s), for example, a CAN (Controller Area Network), though which are not shown in the figure.

The communications unit 100 has the functions to transmit and receive pieces of communications data with other control devices in between. For example, such functions include the functions to transmit and receive communications data of CAN communications.

The state acquisition unit 101 acquires a state(s) of a motor vehicle being a control object or target. The state acquisition unit 101 acquires any one of states among: a control state of the control device 10, a control state of a motor vehicle control system, a neighboring environment state of a motor vehicle, location information of a motor vehicle, a communications state of the control device 10, a state of an operator or driver within a motor vehicle, a process work-load state in a control device, an attack state with respect to the control device 10.

To be specific, a control state of the control device 10 indicates an activation or start-up state of the control device, a sleep state thereof, and/or the like.

To be specific, a control state of a motor vehicle control system indicates such an operational state as running in motor vehicle's motion, turning therein or stopping therein. In addition, the state thereof may be finely classified. To be specific, “running states”, a high speed, an intermediate or middle speed, a low speed, and the like are applicable.

To be specific, a neighboring environment state of a motor vehicle indicates a traffic situation such as congestion or the like, and/or the weather such as snow or the like.

To be specific, location information of a motor vehicle indicates that the motor vehicle is within a tunnel, it is at an intersection and/or the like.

To be specific, a communications state of the control device 10 indicates whether the control device is during communicating with, or it is not during communicating with. In addition, the communications state thereof may be finely classified.

To be specific, a state of an operator or driver within a motor vehicle indicates a state in which the driver is sleeping, tired, or being the like.

To be specific, a process work-load state in a control device indicates whether there is an allowance or margin for the processing when a process work-load in the control device 10 is small, whether there is no margin for the processing when the process work-load therein is large, or the like. In addition, the state therein may be finely classified.

To be specific, an attack state with respect to the control device 10 indicates a case where abnormality is determined by the abnormality determination unit 105. For example, the state includes such a case where attack is caused through a bus different from that through which communications data has been received.

The storage unit 102 is provided with a memory or memories which record an operational program(s) being control processing of the control device 10, and record its control value(s) used at the time of its operations, and a list(s) of communications data in which the communications unit 100 receives the data at a normal time. The memory or memories storing the list(s) thereof include a ROM(s) and/or a RAM(s).

The monitoring determination unit 103 determines whether or not a list of the communications data which becomes as the control target of the communications monitoring unit 104 is to be changed or not to be changed, in accordance with the relationship between state transition information on a state acquired by the state acquisition unit 101 and a list of communications data in the storage unit 102.

The communications monitoring unit 104 monitors communications data received by the communications unit 100. To be specific, a communications ID, a data length, a data value, the quantity of change in the data value, a communications period, a communications frequency and the like are acquired.

The abnormality determination unit 105 defines communications data acquired by the communications monitoring unit 104 as a monitoring result, and defines a list(s) of communications data in the storage unit 102 as a normal value of communications data, so that the abnormality determination unit compares the monitoring result with the normal value each other.

The abnormality determination unit 105 determines abnormality, when a comparison result of a monitoring result is not coincident with a normal value.

When abnormality is determined, the abnormality determination unit 105 may move to abnormality countermeasure processing. For example, a changeover of a communications line(s), a changeover to a standby control device, functional degeneracy of a control device, and the like are executed. When normality is determined, ordinary control processing is continuously executed.

The state transition management unit 106 extracts a transition state(s), on the basis of transition state information of a state acquired by the state acquisition unit 101. To be specific, transitional information of the state acquired one time before by the state acquisition unit 101 is extracted. For example, in a running state in motor vehicle's motion on a control state of a motor vehicle control system, a state to transfer next to “halt or stop” state will be applicable to “low speed” state, or the like. In addition, a state being extracted may exist in a plurality of states.

The monitoring determination unit 103 notifies to the abnormality determination unit 105 so that abnormality is caused, when a state acquired by the state acquisition unit 101 is not coincident with a state extracted by the state transition management unit 106.

The abnormality determination unit 105 determines abnormality, when a state acquired by the state acquisition unit 101 is not coincident with a state extracted by the state transition management unit 106, and also when the notification is made from the monitoring determination unit 103 so that abnormality is caused.

When a state acquired by the state acquisition unit 101 is coincident with a state extracted by the state transition management unit 106, and there exists no change in a state, the monitoring determination unit 103 determines a list of communications data in the storage unit 102 corresponding to the state acquired by the state acquisition unit 101, as a list of communications data to become the monitoring target of the communications monitoring unit 104.

When a state acquired by the state acquisition unit 101 is coincident with a state extracted by the state transition management unit 106, and a state transfers, the monitoring determination unit 103 determines a list that combines a list of communications data corresponding to the state acquired by the state acquisition unit 101 in the storage unit 102 and the list corresponding to the state acquired one time before by the state acquisition unit 101, as a list of communications data to become the monitoring target of the communications monitoring unit 104.

The monitoring determination unit 103 determines to monitor preferentially overlapped pieces of communications data which are overlapped when combining, in a list that combines the list corresponding to the state acquired by the state acquisition unit 101 and the list corresponding to the state acquired one time before by the state acquisition unit 101.

The time measurement unit 107 measures a time from when a state was acquired by the state acquisition unit 101 to when the state transfers to a next state.

When a state transition time when the time measurement unit 107 measures is shorter than a predetermined time, the monitoring determination unit 103 determines a list that combines the list corresponding to the state acquired by the state acquisition unit 101, the list corresponding to the state acquired one time before by the state acquisition unit 101, and the list corresponding to the state acquired two times before by the state acquisition unit 101, as a list to become the monitoring target of the communications monitoring unit 104, on the basis of state transition information being extracted by the state transition management unit 106.

The monitoring determination unit 103 determines to monitor preferentially overlapped pieces of communications data which are overlapped when combining, in the list that combines the list corresponding to the state acquired by the state acquisition unit 101, the list corresponding to the state acquired one time before by the state acquisition unit 101, and the list corresponding to the state acquired two times before by the state acquisition unit 101.

When the monitoring determination unit 103 determines a list that combines the list corresponding to the state acquired by the state acquisition unit 101 and the list corresponding to the state acquired one time before by the state acquisition unit 101, as the list of the monitoring target, and also when there exists no determined combined list, the list production unit 108 produces this determined combined list.

When the monitoring determination unit 103 determines a list that combines the list corresponding to the state acquired by the state acquisition unit 101, the list corresponding to the state acquired one time before by the state acquisition unit 101, and the list corresponding to the state acquired two times before by the state acquisition unit 101, as the list of the monitoring target, and also when there exists no determined combined list, the list production unit 108 produces this determined combined list.

The combinations of transition states which are extracted by the state transition management unit 106 are shown in FIG. 2. As a state acquired by the state acquisition unit 101, exemplarily shown are running states each corresponding to “running” in motor vehicle's motion on a control state of a motor vehicle control system. The running states are classified into a group of four such as a high speed, a middle speed, a low speed, and a halt or stop, so that a transition state(s) to transfer next to each state is extracted. The running states thereinto may be finely classified. Also in another state, a transition state is extracted in a similar manner.

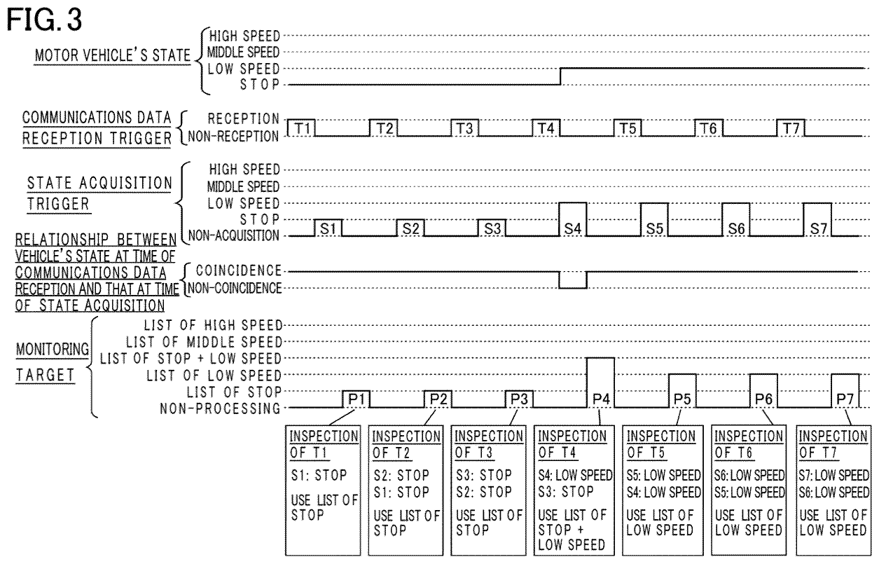

FIG. 3 shows a method that the monitoring determination unit 103 determines a list that combines the list corresponding to the state acquired by the state acquisition unit 101, and the list corresponding to the state acquired one time before, namely combines the lists corresponding to two kinds of states, as the list of the monitoring target. When the state is “stop”, the state to be transferred by the state transition management unit is “low speed”. When communications data T4 is received immediately before a state switches from “stop” to “low speed”, and a state S4 is acquired by the state acquisition unit 101, the state acquired in “S4” becomes “low speed” although a state of the T4 is “stop”, so that the state at the time of communications data reception and the state at the time of state acquisition are not coincident with each other. If a list is determined depending on a state of the monitoring target, a list in a different state is monitored, so that there exists a possibility that erroneous detection and/or an escape of detection occur. According to these considerations, a list that combines the list corresponding to the state acquired by the state acquisition unit 101 and the list corresponding to the state acquired one time before is determined as the list of the monitoring target, whereby it becomes possible to prevent erroneous detection and/or an escape of detection. In accordance with the inspection “P4” of the T4, the monitoring is performed by using a list that combines the list corresponding to the state of “low speed” acquired in “S4” and the list corresponding to the state of “stop” acquired one time before in “S3”.

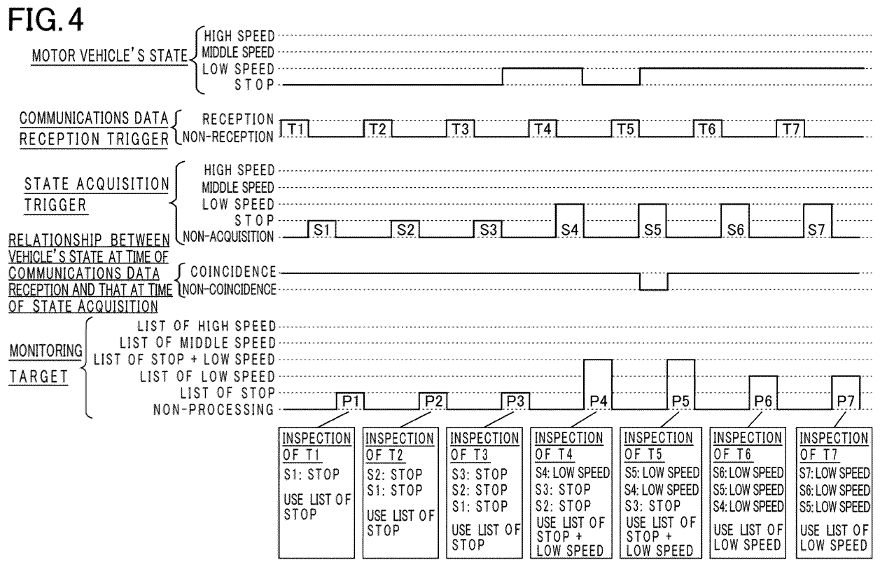

FIG. 4 shows a method that the monitoring determination unit 103 determines a list that combines the list corresponding to the state acquired by the state acquisition unit 101, the list corresponding to the state acquired one time before, and the list corresponding to the state acquired two times before, namely combines the lists of three kinds of states, as the list of the monitoring target, when a state transition time measured by the time measurement unit 107 is shorter than a predetermined time. When the state is “stop”, the state to be transferred by the state transition management unit is “low speed”. When the state is “low speed”, the state to be transferred by the state transition management unit is “middle speed” or “stop”. When a state switches between “stop” and “low speed” in an interval which is shorter than a predetermined time, if a list that combines the list corresponding to the state and the list corresponding to the state one time before is determined as the list of the monitoring target, there exists a case where erroneous detection and/or an escape of detection occur. When communications data T5 is received immediately before a state switches from “stop” to “low speed”, and a state S5 is acquired by the state acquisition unit 101, the state acquired in “S5” becomes “low speed” although the state of the T5 is “stop”, so that the state at the time of communications data reception and the state at the time of state acquisition are not coincident with each other. When a list that combines the list corresponding to the state acquired by the state acquisition unit 101 and the list corresponding to the state acquired one time before is determined as the list of the monitoring target, in the inspection “P5” of the T5, the monitoring is performed by using a list that combines the list corresponding to the state of “low speed” acquired in “S5” and the list corresponding to the state of “low speed” acquired one time before “S4”, a list in a different state is monitored, so that there exists a possibility that erroneous detection and/or an escape of detection occur. According to these considerations, a list that combines the list corresponding to the state acquired by the state acquisition unit 101, the list corresponding to the state acquired one time before, and the list corresponding to the state acquired two times before is determined as the list of the monitoring target, whereby it becomes possible to prevent erroneous detection and/or an escape of detection. In accordance with the inspection “P5” of the T5, the monitoring is performed by using a list that combines the list corresponding to the state of “low speed” acquired in “S5”, the list corresponding to the state of “low speed” acquired one time before “S4”, and the list corresponding to the state of “stop” acquired two times before “S3”.

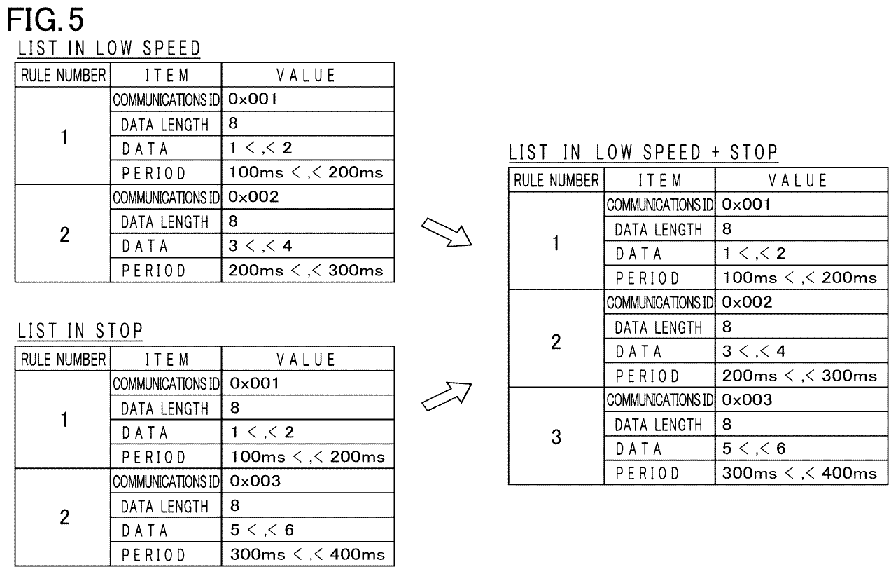

FIG. 5 shows a method that the list production unit 108 produces a list that combines the list corresponding to the state acquired by the state acquisition unit 101 and the list corresponding to the state acquired one time before. The list corresponding to the state of “low speed” acquired by the state acquisition unit 101 and the list corresponding to the state of “stop” acquired one time before are combined together with each other. A rule of a rule number 1 of the list corresponding to the state of “low speed” and a rule of a rule number 1 of the list corresponding to the state of “stop” are overlapping and unified as one rule. The overlapped rule are set to a smaller rule number in order to monitor preferentially. If there are other rules that should be given priority, the rule number may be changed.

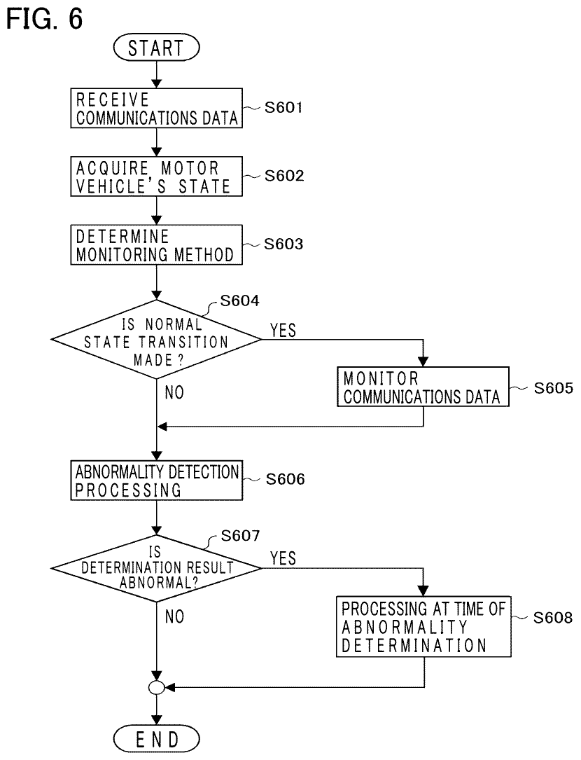

Next, the explanation will be made in detail referring to FIG. 6 for abnormality detection processing of the control device 10. FIG. 6 is a flowchart showing the flows of the processing from communications data's reception of the communications unit 100 according to Embodiment 1, passing through abnormality detection processing, until the processing of determination result is executed.

At Step S601, the communications unit 100 receives communications data. After finishing Step S601, the processing proceeds to Step S602.

At Step S602, the state acquisition unit 101 acquires a motor vehicle's state. After finishing Step S602, the processing proceeds to Step S603.

At Step S603, the monitoring determination unit 103 determines the monitoring target of the communications monitoring unit 104. After finishing Step S603, the processing proceeds to Step S604.

When the monitoring determination unit 103 determines that a state acquired by the state acquisition unit 101 is a normal state transition at Step S604, the processing proceeds to Step S605. When the state is not the normal state transition, the processing proceeds to Step S606.

At Step S605, the communications monitoring unit 104 monitors communications data corresponding to the list in the storage unit 102 which is the monitoring target determined by the monitoring determination unit 103. After finishing Step S605, the processing proceeds to Step S606.

At Step S606, the abnormality determination unit 105 compares a monitoring result of the communications monitoring unit 104 with the list in the storage unit 102, and determines whether or not abnormality is caused due to illegal or unauthorized data. Also when the state is not the normal state transition determined by the monitoring determination unit 103, it is determined that the abnormality is caused. After finishing Step S606, the processing proceeds to Step S607.

When the abnormality determination unit 105 determines that the abnormality is caused at Step S607, the processing proceeds to Step S608. When the abnormality determination unit 105 determines normality, the abnormality detection processing is ended.

At Step S608, the processing at the time of abnormality determination is executed. After finishing Step S608, the abnormality detection processing is ended.

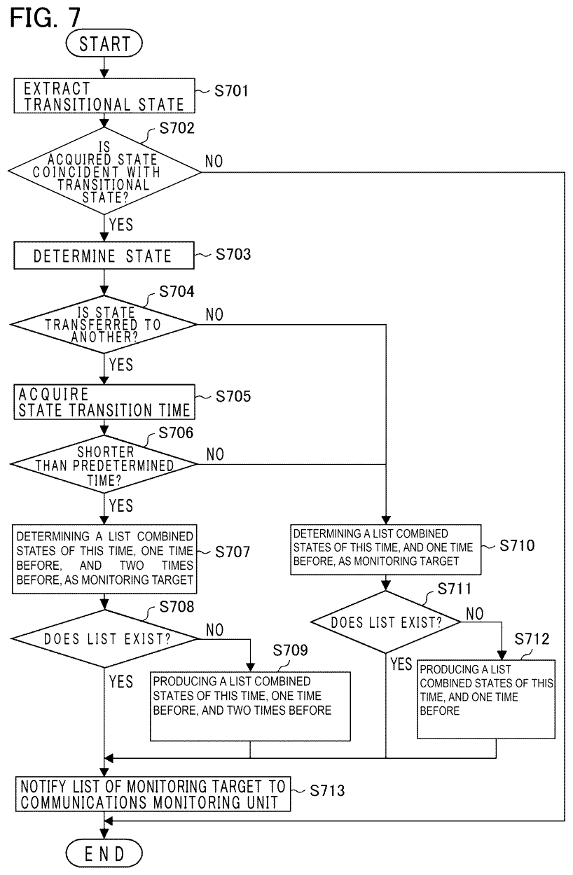

Next, the explanation will be made in detail referring to FIG. 7 for monitoring-method determination (Step S603) in FIG. 6. FIG. 7 is a flowchart showing the flows of monitoring-method determination processing in the control device 10 according to Embodiment 1.

At Step S701, the state transition management unit 106 extracts a state to be transferred next from the state acquired one time before by the state acquisition unit 101. There may be a plurality of the states to be transferred next. After finishing Step S701, the processing proceeds to Step S702.

At Step S702, the monitoring determination unit 103 compares between a transition state extracted by the state transition management unit 106 and a state acquired by the state acquisition unit 101 to determine whether these coincide. In a case of “coincidence”, the processing proceeds to Step S703. In a case of “non-coincidence”, it is determined that abnormality is caused, and thus, the monitoring-method determination processing is ended.

At Step S703, because the state acquired by the state acquisition unit 101 is a state that transferred from the state acquired one time before, the state is determined as a state at the time of receiving communications data of the communications unit 100. After finishing Step S703, the processing proceeds to Step S704.

At Step S704, it is confirmed whether or not the state determined at Step S703 transferred from the state one time before to another state. When the state determined at Step S703 transferred from the state one time before to another state, the processing proceeds to Step S705. When the state is not transferred from the state one time before to another state, the processing proceeds to Step S710.

At Step S705, the time measurement unit 107 measures a time from a state before transition to a state after the transition. After finishing Step S705, the processing proceeds to Step S706.

When a time measured by the time measurement unit 107 is shorter than a predetermined time at Step S706, the processing proceeds to Step S707. When the time is longer than a predetermined time, the processing proceeds to Step S710.

At Step S707, the monitoring determination unit 103 determines, as the monitoring target of the communications monitoring unit 104, a list that combines the list of communications data stored in the storage unit 102 defined by the state determined at Step S703, the list of communications data stored in the storage unit 102 defined by the state acquired one time before, and the list of communications data stored in the storage unit 102 defined by the state acquired two times before. After finishing Step S707, the processing proceeds to Step S708.

At Step S708, when there exists a list determined at Step S707, the processing proceeds to Step S713. When there does not exist a list determined at Step S707, the processing proceeds to Step S709.

At Step S709, the list production unit 108 produces a list by combining the list of communications data stored in the storage unit 102 defined by the state determined at Step S703, the list of communications data stored in the storage unit 102 defined by the state acquired one time before, and the list of communications data stored in the storage unit 102 defined by the state acquired two times before. After finishing Step S709, the processing proceeds to Step S713.

At Step S710, the monitoring determination unit 103 determines, as the monitoring target of the communications monitoring unit 104, a list that combines the list of communications data stored in the storage unit 102 defined by the state determined at Step S703, and the list of communications data stored in the storage unit 102 defined by the state acquired one time before. After finishing Step S710, the processing proceeds to Step S711.

At Step S711, when there exists the list determined at Step S710, the processing proceeds to Step S713. When there does not exist the list determined at Step S710, the processing proceeds to Step S712.

At Step S712, the list production unit 108 produces a list by combining the list of communications data stored in the storage unit 102 defined by the state determined at Step S703, and the list of communications data stored in the storage unit 102 defined by the state acquired one time before. After finishing Step S712, the processing proceeds to Step S713.

At Step S713, the monitoring determination unit 103 notifies the list of the monitoring target to the communications monitoring unit 104. After finishing Step S713, the monitoring determination processing is ended.

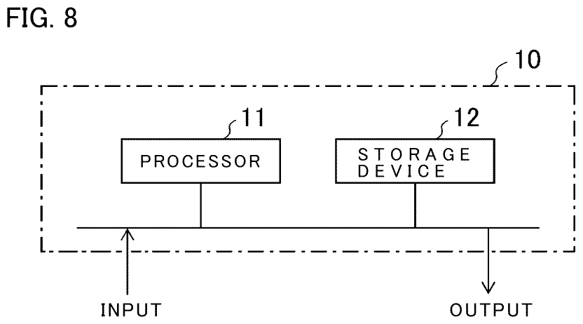

It should be noted that, as an example of hardware is shown in FIG. 8, the control device 10 is constituted of a processor 11 and a memory or storage device 12. The storage device 12 is provided with a volatile storage device of a random access memory (RAM) or the like, and with a nonvolatile auxiliary storage device of a flash memory or the like, for example. In addition, in place of the flash memory, an auxiliary storage device of a hard disk may be provided with. The processor 11 executes a program(s) inputted from the storage device 12. In this case, the program(s) is inputted into the processor 11 from the auxiliary storage device by way of the volatile storage device. Moreover, the processor 11 may output its data of a calculated result(s) or the like into the volatile storage device of the storage device 12, or may store the data into the auxiliary storage device by way of the volatile storage device.

Note that, in Embodiment 1 described above, the explanation has been made, by way of example, for the control device which is used as an on-vehicle or onboard control device. However, the control device(s) disclosed in the disclosure of the application concerned is not necessarily limited to the onboard one. For example, it is possible to utilize for a control device(s) connected to a communications line(s) which requires a mechanism having a high degree of security strength, and also the mechanism having abnormality detection capabilities of the a control device(s) at an early stage.

According to Embodiment 1 described above, effects can be achieved in the control processing as obtaining those described below.

In a conventional control device, an abnormality detection method has been so arranged that a monitoring method of communications data is changed on the basis of a motor vehicle's state, and abnormal data is detected. On the other hand, the control device according to Embodiment 1 comprises a configuration to perform, from the relationship between state transition information and a list of communications data, determination whether a list is to be changed or not to be changed when communications data is received earlier before a predetermined time when the state is switched, and the configuration to compare whether or not a monitoring result is coincident with a normal value, whereby abnormality of the control device is detected.

According to this arrangement, earlier before a predetermined time when the state is changed over, it becomes possible to detect abnormality of illegal or unauthorized communications data received, which is caused due to cyber-security attack, without causing erroneous detection and/or an escape of detection.

In addition, the control device according to Embodiment 1 comprises a state acquisition unit for acquiring a motor vehicle's state, and a state transition management unit for extracting a transition state of a state acquired by the state acquisition unit, on the basis of state transition information. According to this arrangement, the contents of the list to be used not only for one state, but also for the state and the transition state can be narrowed down.

Moreover, the control device according to Embodiment 1 comprises in the monitoring determination unit a configuration which can determine a list that combines the list acquired by the state acquisition unit and the list acquired one time before by the state acquisition unit, on the basis of a state extracted by the state transition management unit. According to this arrangement, even when a state is changed, it becomes possible to perform the monitoring without changing over a list to another list corresponding to a different state.

Furthermore, when a time measured by a time measurement unit for measuring a time from when a state acquisition unit acquires a state to when the state transfers to a next state is shorter than a predetermined time, the control device according to Embodiment 1 comprises a configuration which can determine a list that combines the list corresponding to the state acquired by the state acquisition unit, the list corresponding to the state acquired one time before by the state acquisition unit, and the list corresponding to the state acquired two times before. According to this arrangement, even when a state is changed in a short period, it becomes possible to perform the monitoring without changing over a list to another list corresponding to a different state.

Still furthermore, when there does not exist a list that combines the list corresponding to the state acquired by the state acquisition unit and the list corresponding to the state acquired one time before by the state acquisition unit, by the monitoring determination unit, the control device according to Embodiment 1 comprises a configuration to produce a combined list by the list production unit. According to this arrangement, even when a state is changed, it becomes possible to perform the monitoring without changing over a list to another list corresponding to a different state.

Yet furthermore, when there does not exist a list that combines the list corresponding to the state acquired by the state acquisition unit, the list corresponding to the state acquired one time before by the state acquisition unit, and the list corresponding to the state acquired two times before, by the monitoring determination unit, the control device according to Embodiment 1 comprises a configuration to produce a combined list by the list production unit. According to this arrangement, even when a state is changed, it becomes possible to perform the monitoring without changing over a list to another list corresponding to a different state.

Yet still furthermore, by the monitoring determination unit, the control device according to Embodiment 1 comprises a configuration to combine the list corresponding to the state acquired by the state acquisition unit, and the list corresponding to the state acquired one time before by the state acquisition unit, and to monitor overlapped pieces of communications data in the combined list preferentially. According to this arrangement, the inspection is performed on communications data starting from communications data having a high possibility in its occurrence, whereby, even when a state to achieve the enhancement of processing time is changed, it becomes possible to perform the monitoring without changing over a list to another list corresponding to a different state.

Yet still furthermore, the control device according to Embodiment 1 comprises a configuration to combine the list corresponding to the state acquired by the state acquisition unit, the list corresponding to the state acquired one time before by the state acquisition unit, and the list corresponding to the state acquired two times before, by the monitoring determination unit, and to monitor overlapped pieces of communications data in the combined list preferentially. According to this arrangement, the inspection is performed on communications data starting from communications data having a high possibility in its occurrence, whereby, even when a state to achieve the enhancement of processing time is changed, it becomes possible to perform the monitoring without changing over a list to another one.

In the present disclosure of the application concerned, exemplary embodiments are described; however, various features, aspects and functions described in an embodiment(s) are not necessarily limited to the applications of a specific embodiment(s), but are applicable in an embodiment(s) solely or in various combinations.

Therefore, limitless modification examples not being exemplified can be presumed without departing from the scope of the technologies disclosed in Description of the disclosure of the application concerned. For example, there exists a modification example which is included as a case where at least one constituent element is modified, added to or eliminated from a constituent element(s) of another embodiment.

### EXPLANATION OF NUMERALS AND SYMBOLS

Numeral “10” designates a control device; “100”, communications unit; “101”, state acquisition unit; “102”, storage unit; “103”, monitoring determination unit; “104”, communications monitoring unit; “105”, abnormality determination unit; “106”, state transition management unit; “107”, time measurement unit; and “108”, list production unit.

1.-8. (canceled)

9. A control device which performs a control of a control target, the control device, comprising:
communications circuitry for transmitting and receiving communications data with other control devices;
state acquisition circuitry for acquiring a state of the control target from the control target;
storage circuitry for storing each list of specifications of the communications data representing each state of the control target at a normal time;
monitoring determination circuitry for determining whether or not the state acquired by the state acquisition circuitry transferred from the state acquired one time before to another state; when determining that the state transferred, determining a list that combines the list in the storage circuitry corresponding to the state acquired this time by the state acquisition circuitry and the list in the storage circuitry corresponding to the state acquired one time before, as a list of a monitoring target,
communications monitoring circuitry for monitoring communications data corresponding to the list of the monitoring target determined by the monitoring determination circuitry; and
abnormality determination circuitry for comparing the communications data monitored by the communications monitoring circuitry with the specifications of the communications data included in the list of the monitoring target, and determining whether unauthorized data is caused or not on a basis of a comparison result.

10. The control device according to claim 9, wherein the monitoring determination circuitry for determining whether a state transition time from a transition one time before to a transition this time is shorter than a determination time; when determining that the state transition time is shorter, changing the list of the monitoring target to a list that combines the list in the storage circuitry corresponding to the state acquired this time by the state acquisition circuitry, the list in the storage circuitry corresponding to the state acquired one time before, and the list in the storage circuitry corresponding to the state acquired two times before.

11. The control device according to claim 9, wherein the monitoring determination circuitry for determining an overlapped part in the combined list which was overlapped when combining, as a priority monitoring list part, and
wherein the communications monitoring circuitry for monitoring preferentially communications data corresponding to the priority monitoring list part.

12. The control device according to claim 10, wherein the monitoring determination circuitry for determining an overlapped part in the combined list which was overlapped when combining, as a priority monitoring list part, and
wherein the communications monitoring circuitry for monitoring preferentially communications data corresponding to the priority monitoring list part.
